(19) United States
(12) Patent Application Publication
(10) Pub. No.: US 2002/0076027 A1
(43) Pub. Date: Jun. 20, 2002

(54) Fallback to message compose on synchronous call attempt

(75) Inventors: Paul M. Bernnan, Toronto (CA); John E. Lumsden, Toronto (CA)

Correspondence Address: SMART AND BIGGAR, 438 UNIVERSITY AVENUE, SUITE 1500 BOX 111, TORONTO, ON, M5G2K8, CA

(73) Assignee: NORTEL NETWORKS LIMITED

(21) Appl. No.: 09/739,708

(22) Filed: Dec. 20, 2000

(51) Int. Cl. H04M 3/42

(52) U.S. Cl. 379/211.01; 379/211.02

(57) ABSTRACT

A method and system for fallback to message compose on the calling party's own supervisory (messaging) system on a synchronous call attempt. In particular, where a calling party cannot have a synchronous call with a called party due to busy signal, no answer, reaching a called party's messaging system or the wrong person or other reasons, address information for the called party is retrieved, the call is dropped (disconnected or the call request is discontinued), and a message compose session is established for the calling party, with the called party's address information pre-filled (i.e. destination number, voice mail number, e-mail address, pager number, etc.). In this way, the calling party does not need to take any additional steps to compose a message or to determine the called party's address information or alternate address information and, further, can compose a message using the calling party's own message compose system.

### FIELD OF THE INVENTION

The present invention relates to communications call handling systems, and more particularly, to a method and system for fallback to message compose on a synchronous call attempt.

### BACKGROUND OF THE INVENTION

A calling party making a call to a called party generally intends a synchronous communication with the called party. However, in various circumstances, the called party may not be available, the calling party will receive a busy signal, there will be no answer, or the call will be taken by a call answering or messaging system or the wrong person or the like. In these cases, the calling party may wish to compose and send a message to the called party. Of course, if the call is taken by a call answering or messaging system or the like, the calling party has an opportunity to leave a message, however, the called party's voice messaging system may cause the calling party to be rushed in composing a message such that the message may not include all appropriate details. Even in the case where the called party's messaging system may have advanced features, the features may not be familiar to the calling party. This can occur frequently because of a lack of standardization in telephone user interfaces (TUIs) for these call answering or messaging systems. Further, in this situation, the calling party will generally not have any record of the details of the message left.

With some current messaging systems a subscriber that wishes to send a message to another party or parties can dial into their own voice messaging system and then enter a voice messaging application in which they record a message and enter a destination address or addresses to which the message is to be sent. These systems are more specifically designed for situations when the called party does not wish to contact the called party directly and knows that they intend to send a message. Other current systems allow a subscriber to call to directory assistance or a special database server for information or alternative addresses for a called party. The calling party may then try to contact the called party or record and send a message to the called party. These systems are indirect systems in which the calling party must first call an intermediate number before a connection is attempted with the called party or before a message can be sent.

### SUMMARY OF THE INVENTION

The present invention provides a method and system for fallback to message compose on a calling party's own messaging system given an unsuccessful synchronous call attempt from the calling party to the called party. In particular, where a calling party cannot have a synchronous call with a called party about a subject due to busy signal, no answer, reaching a called party's voice messaging system or the wrong person or other reasons, address information for the called party is retrieved, the call is dropped (e.g. disconnected or the call attempt is discontinued), and a message compose session is established for the calling party, with the called party's address information pre-filled (i.e. destination number, voice mail number, e-mail address, pager number, etc.). In this way, the calling party does not need to take any additional steps to compose a message or to determine the called party's address information or alternate address information and, further, can compose a message using the calling party's own message compose system and using a variety of messaging options including voice messaging.

In accordance with an aspect of the present invention there is provided a method for handling an unsuccessful synchronous call attempt from a calling party to a called party which includes monitoring a synchronous call attempt from the calling party to the called party, determining at least one communication address related to the called party, dropping the synchronous call attempt to the called party, allowing the calling party to compose a message, and sending the message to the determined communication address. As an alternative, the dropping may occur prior to the determining the at least one communication address. The at least one communication address may include a telephone number, pager number, e-mail address, voice messaging address, mobile phone number, and Internet instant messaging address.

In a particular case, the invention may also include determining that the synchronous call attempt to the called party is unsuccessful. In this case, the determining that the synchronous call attempt to the called party is unsuccessful may include detecting a busy signal, detecting a predetermined number of rings, detecting transfer to a messaging system or detecting an indication from the calling party that the synchronous call attempt to the called party is unsuccessful. The indication from the calling party may be by the calling party pressing a predetermined key or keys on a communication device, by a vocal command, or the like. The provision of a way for the calling party to indicate that the call is unsuccessful allows the calling party to deal with situations where the wrong person answers the call (for example, a child) or the like.

In another particular case, the determining at least one communication address may include using information about the called party in a query to at least one database to obtain other information about the called party. Further, the other information about the called party may also be used in a query to at least one database to obtain further information about the called party. The information and other information about the called party may include name, communication addresses, such as physical address, phone numbers (addresses), information about the communication devices available to the called party and about their functionality and capability for various messaging types, information about the called party's assistant and communication information for the assistant, and other information that may be relevant in communications.

In another particular case, the allowing the calling party to compose a message includes, where there are a plurality of communication addresses available for the called party, presenting the calling party with a list of messaging options based on the plurality of communication addresses, allowing the calling party to select a messaging option for use, and commencing a message compose session related to the selected messaging option and pre-filling a communication address for the message with a communication address related to the messaging option. In this case, it may be useful to also determine the called party's communication addresses that are available for use, for example, by comparing the determined called party's addresses with the message compose capability of a communications device of the calling party. In this way, the calling party will not have to choose from a list that includes options that are not available to the calling party.

In accordance with another aspect of the present invention there is provided a computer readable medium containing computer executable code which adapts a processor for a communication system to perform the method of the aspect of the invention described above. In particular, the processor may be adapted to monitor a synchronous call attempt from the calling party to the called party, determine at least one communication address related to the called party, drop the synchronous call attempt to the called party, allow the calling party to compose a message, and send the message to the determined communication address. As above, various particular cases may apply. For example, the processor may be adapted to determine that the synchronous call attempt to the called party is unsuccessful, which determination may be by detecting an indication from the calling party such as pushing a key or a vocal command.

In accordance with another aspect of the present invention there is provided a method for handling a synchronous call attempt from a calling party to a called party that includes monitoring a synchronous call attempt from the calling party to the called party, detecting an indication from the calling party that the calling party wishes to send a message, determining at least one communication address related to the called party, allowing the calling party to compose a message, and sending the message to the determined communication address. In this aspect, the call to the called party may not necessarily be dropped even though the calling party wishes to send a message, for example, the calling party may wish to send a drawing by e-mail or the like while continuing the synchronous discussion. Similar to the above aspects, the detecting of the indication from the calling party may include detecting the calling party pressing a predetermined key or keys on a communication device or detecting the calling party using a vocal command.

In accordance with another aspect of the present invention there is provided a system for handling an unsuccessful synchronous call attempt from a calling party to a called party that includes a monitoring system for monitoring a synchronous call attempt from the calling party directed to the called party, a detection system for determining that the synchronous call attempt from the calling party to the called party is unsuccessful, an addressing system for determining at least one address for the called party, a dropping system for dropping the synchronous call attempt to the called party, a message system for allowing the calling party to compose a message for the called party, and a sending system for sending the message to the address determined by the addressing system. In a particular case, the addressing system may include at least one database containing the called party's address information, a database query system for querying the database for the called party's address information, and a data communication system for providing the called party's address information to the message system.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate example embodiments of this invention:

FIG. 1 is a schematic diagram of a communications system according to an embodiment of the invention

FIG. 2 is a flowchart of a method according to an embodiment of the invention;

FIG. 3 is a schematic diagram of a communications system according to another embodiment of the invention;

FIG. 4 is a flowchart of a method according to another embodiment of the invention; and

FIG. 5 is a flowchart detailing a portion of the method of FIG. 4.

### DETAILED DESCRIPTION

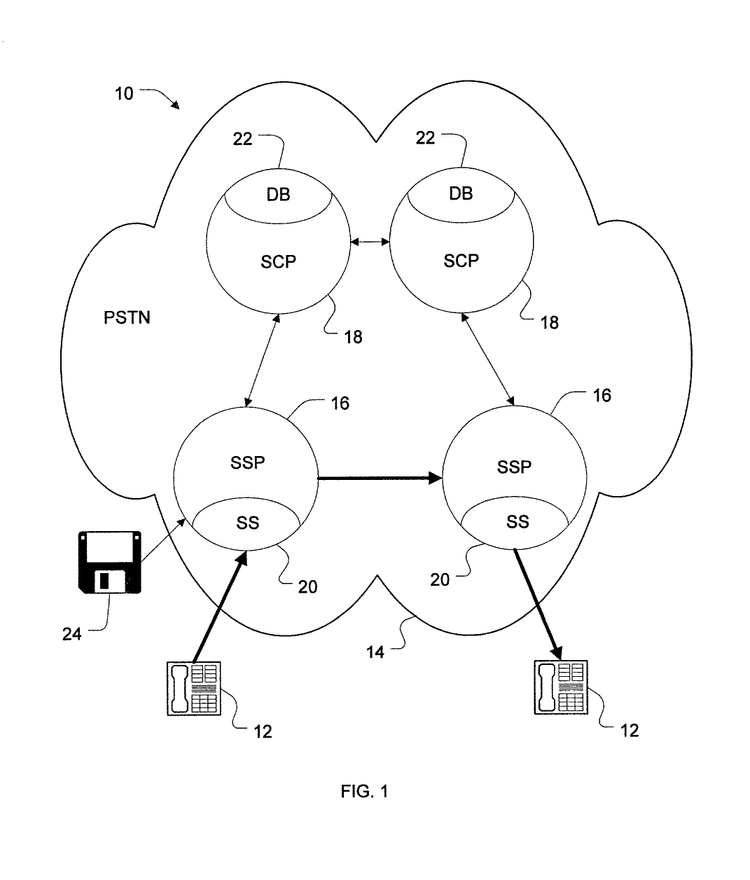

FIG. 1 is a schematic diagram of a communications system 10 according to an embodiment of the invention. The communication system 10 includes a plurality of communication devices (CDs) 12 connected to the public switched telephone network (PSTN) 14. In this embodiment, only two communication devices 12 are shown, which may be conventional telephone handsets. The PSTN 14 includes a plurality of processors such as Service Switching Points (SSP) 16 (two shown) and Service Control Points (SCP) 18 (two shown). The SSPs 16 are connected to each other and connected to the communication devices 12 through the PSTN 14. The SCPs 18 are connected to the SSPs 16 through a control network that operates within but separate from the PSTN 14. Generally, an SSP 16 will be associated with one SCP 18, designated as a local SCP 18 for that SSP 16.

Each SSP 16 includes a supervisory system (SS) 20 that monitors calls made from CDs serviced by the SSP 16. The supervisory system 20 may be a separate system or may be provided as an addition to or a part of a conventional voice messaging system or the like. The supervisory system 20 may be arranged to be active on all calls local to that SSP 16 or only on local calls from a subscriber to the supervisory features of this invention.

Each SCP 18 includes a database (DB) 22 including information relating to users of the supervisory system 20. In particular the database includes at least one communication address (such as a phone number) for a user and may also include information regarding many of a user's communication addresses such as as telephone numbers, mobile phone numbers, voice messaging addresses, pager numbers, e-mail addresses, instant messaging addresses, and the like as is explained in more detail below.

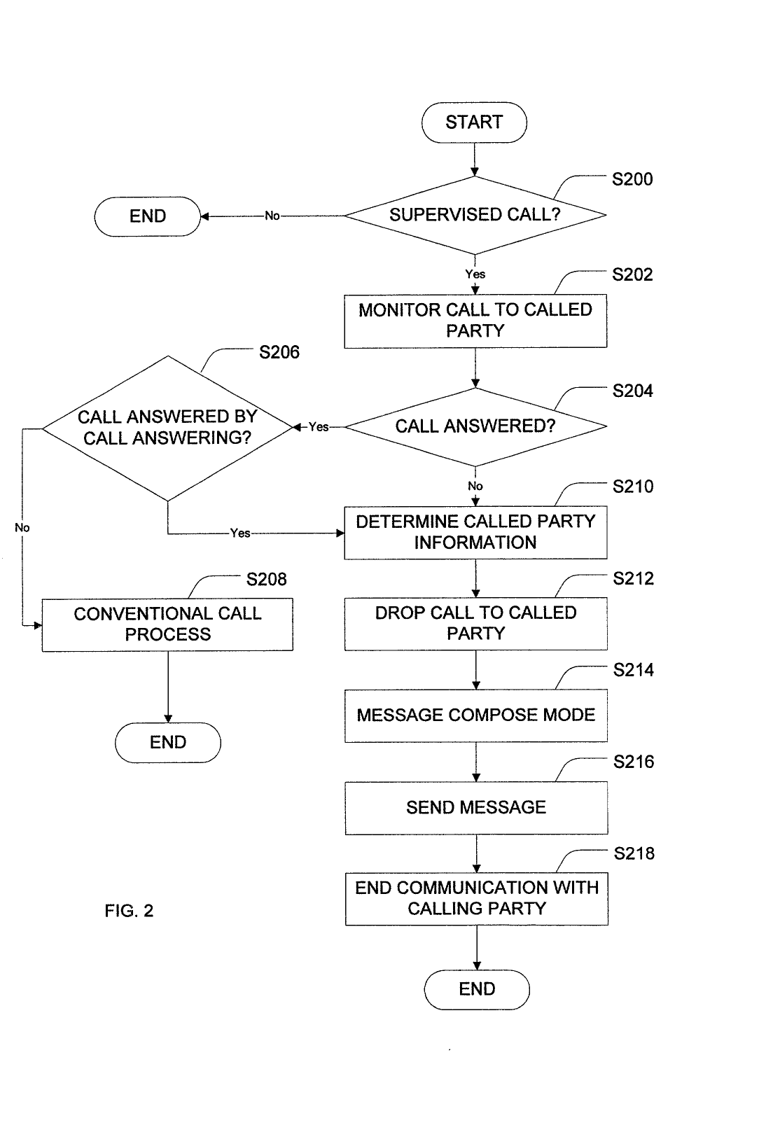

FIG. 2 is a flowchart of a method undertaken at the SSP 16 according to an embodiment of the invention. The method begins when a calling party uses a communication device 12 serviced by the SSP 16, in this case, a telephone, to call a called party. At this time, the SSP 16 identifies the call as one that is to be supervised (S200). For example, the SSP 16 could identify the call as originating from a triggering number that causes the supervisory system 20 to be activated. The supervisory system 20 then joins the call leg between the calling party and the SSP 16 and monitors the call (S202).

The supervisory system 20 first determines if the call is answered (S204). This determination can be made by the supervisory system 20 by detecting a busy signal, waiting for a predetermined number of rings, or waiting for a predetermined dual tone multi-frequency (DTMF) signal or the like from the calling party to indicate that the calling party would like to leave a message because synchronous communication is not possible.

If the call is answered, it is then determined if the call has been answered by a call answering or messaging system or by a natural person (S206). The detection of whether or not the call is answered by a messaging system or by a natural person may be performed automatically by the supervisory system 20 by various methods, such as, for example, that described in U.S. patent application Ser. No. 09/216,971 entitled “Method and System for Estimation of a Source of a Voice Signal” by K. Ramanan or, alternatively, may be indicated by the calling party sending DTMF tones or the like. In any case, the calling party may preferably be provided with an opportunity to listen to the called party's voice messaging message (i.e. intake message) prior to the supervisory system 20 disconnecting the call, as described below. In a particular case, the called party's messaging system may be a part of the called party's supervisory system 20.

If the call is answered by a natural person, the call may proceed in the conventional manner (S208). In this case, it may not be necessary for the supervisory system 20 to continue to monitor the call.

If the call is not answered or is answered by a call answering or messaging system, the calling party's supervisory system 20 will determine address information for the called party (S210). For example, the supervisory system 20 may send a request to the local SCP 18 to provide an alternate number/address for the called party that can be used for messaging. This alternate number/address may be the called party's voice mail address. The local SCP 18 may query its own database 22 or, if different, the database 22 at the called party's local SCP 18 to determine the called party's voice mail address and returns this to the supervisory system 20. If the call is answered by a call answering or messaging system, the supervisory system 20 may simply record the called party's destination number (DN) as the messaging number for the called party, or alternatively, may query the SCP 18 as aforedescribed.

After receiving one or more messaging addresses for the called party, the supervisory system 20 then drops the call leg to the DN, or the attempt to establish a call leg to the DN (S212). However, the call leg from the calling party to the supervisory system 20 is maintained.

The supervisory system 20 then enters a message compose mode to allow the calling party to compose a voice mail message in which the called party's voice mail address may be automatically entered as a destination address (S214). The supervisory system 20 could transfer (using, for example, the SSP 16) the calling party to a conventional voice messaging system and monitor the call or the functions of the supervision and a conventional voice messaging system could be combined in the supervisory system 20 of this embodiment. The message compose mode functions in a conventional manner allowing the calling party to record a voice mail message, perhaps including advanced features such as adding to the message, deleting all or part of the message and re-recording, or the like. Since the calling party is either a subscriber or a user of the supervisory system 20, the message compose mode commands or controls will be reasonably familiar to the calling party. Once the calling party completes composing the voice mail message, the supervisory system 20 sends the voice mail message to the called party voice mail address (S216). The supervisory system 20 then drops the call leg with the calling party (S218) and the method ends.

In the case that the called party does not have a voice mail address, the supervisory system 20 may have recorded or may receive the called party's phone number as the called party's only address and be configured to periodically redial the called party's phone number and attempt to deliver the calling party's recorded message.

In an alternative arrangement of this embodiment, the called party's supervisory system 20 or SSP 16 may also provide some of the functionality according to the method. For example, the called party's supervisory system 20 or SSP 16 may monitor the call to the called party and, after a predetermined number of rings, will generate a “forward-no answer” message indicating that the call is being forwarded to a call answering or messaging system. This forward-no answer message may also be sent to the calling party's supervisory system 20 or SSP 16 and include the called party's call answering or messaging system address.

As shown in FIG. 1, the SSP 16 may be loaded with software (computer executable code) from a computer readable media such as a floppy disk 24 adapting the SSP 16 to perform the functions and methods of the supervisory system 20 described.

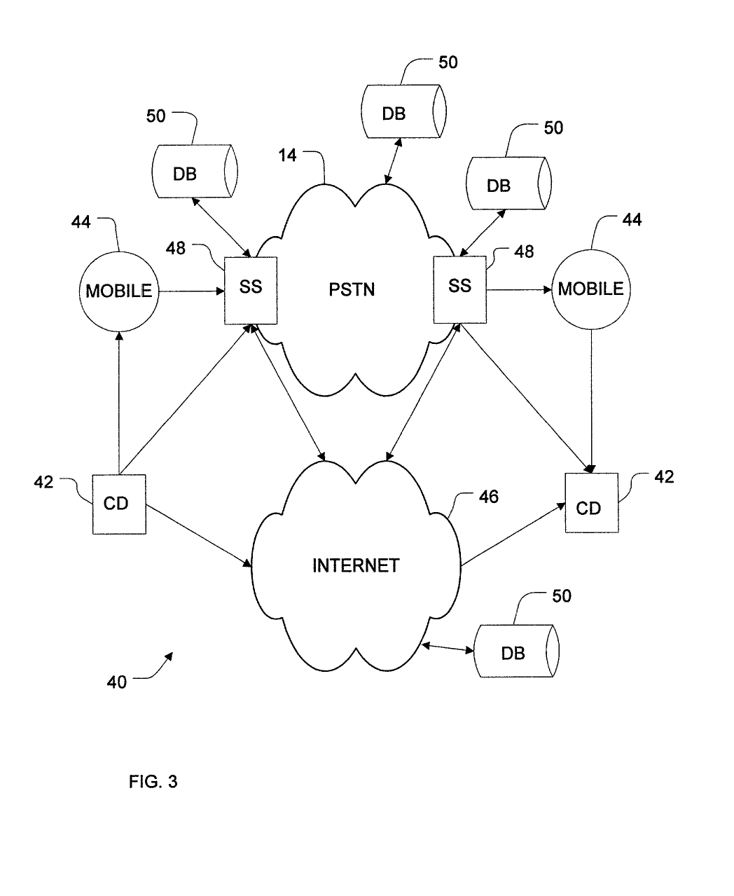

As will be understood, the above embodiment relates most clearly to a conventional telephone communications system, however, the principles of the above embodiment may also be applied to communications systems in general. FIG. 3 is a schematic diagram of a communications system 40 according to another embodiment of the invention.

The communications system 40 includes a plurality of communication devices (CDs) 42 connected to at least one of a mobile network 44, the public switched telephone network (PSTN) 14, the Internet 46, or other networks such as satellite networks (not shown) or the like. In FIG. 3, only two communication devices 42 are shown, one representing the communication device 42 of a calling party and the other representing the communication device 42 of the called party.

The communication device 42 may be a computer, a telephone (conventional or advanced), a mobile phone, a personal digital assistant (PDA), a pager, or the like. As will be described further below, the characteristics and capabilities of a particular communication device 42 will determine the available functionality. Preferably, the communication device 42 is a computer which includes input devices such as a microphone and a keyboard and ouput devices such as a monitor and a speaker. In this case, the computer may also be adapted to perform some of the functions and methods of a supervisory system by computer executable codes stored on a computer readable media such as a floppy disk. As shown in FIG. 3, the communication device 42 may be connected to one or all of the PSTN 14, Internet 46, and a mobile network 44. This may be achieved by, for example, using a mobile voice/data modem (not shown) or the like. Simultaneous connection to a plurality of networks may also be possible, for example by using an ethernet connection for the Internet 46, using a mobile voice/data modem for the mobile network 44, and a voice/data modem with wired connection for the PSTN 14.

Returning to FIG. 3, the communications system 40 also includes one or more supervisory systems (SS) 48 and one or more databases (DB) 50. In this embodiment, the supervisory systems 48 are shown as being associated with (situated on/at) the PSTN 14, however, the supervisory systems 48 could also be associated with (situated on/at) certain communication devices 42, such as a computer or an advanced telephone, or on other networks. When the supervisory systems 48 are on a network, it is possible for there to be a common shared supervisory system 48 available to both the calling party and called party communication devices 42. In this embodiment, databases 50 are shown associated with (situated on/at) the PSTN 14, Internet 46 and supervisory systems 48, respectively, however, the databases may also be associated with certain communication devices 42, such as a computer or an advanced telephone, or other networks. Further, both the supervisory systems 48 and the databases 50 or their functionality can also be distributed such that they are associated with (situated on/at) a plurality of separate networks or devices. As will be understood, the supervisory systems 48 and the databases 50 may generally be associated with (situated on/at) places in the communication system 40 at which processors are available, such as, SSPs 16, SCPs 18 (shown in FIG. 1), communications devices 42 (such as computers or intelligent phones), Internet hubs, PBXs and the like.

In this embodiment, similar to the previously described embodiment, the supervisory system 48 supervises or monitors calls placed by the calling party's communication device 42 and includes a message compose mode that allows a calling party to compose a message. In this case, various types of messages such as voice, text, video and the like may be available depending on the capabilities and functionality of the calling party's communication device 42. Again, the databases 50 store user information regarding a user's communication addresses (a user may be a calling party or a called party) such as telephone numbers, fax numbers, mobile phone numbers, pager numbers, e-mail addresses, instant messaging addresses, physical addresses and the like. Preferably, the databases 50 also include user information regarding the user's communication devices' 42 capability for sending and receiving various message types.

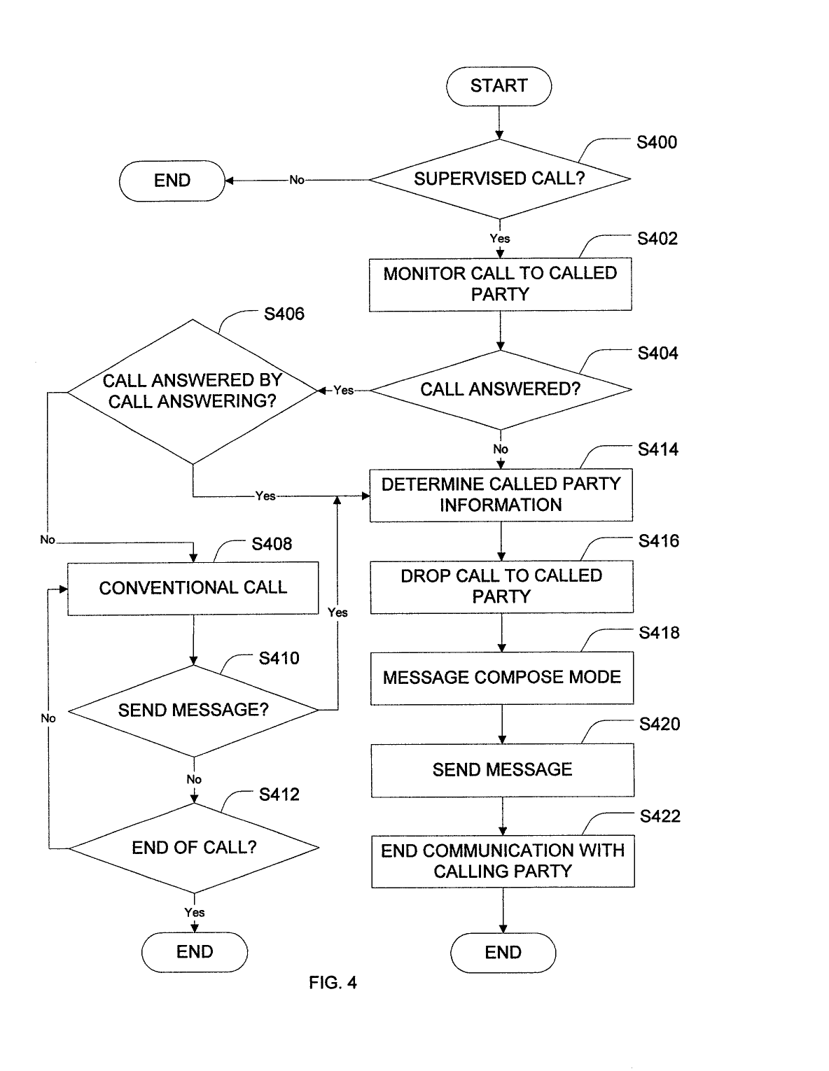

FIG. 4 is a flowchart of a method performed by the supervisory system 40 according to an embodiment of the invention.

The method begins when a calling party uses the communication device 42 to call a called party, for example, using a voice modem of a computer. The calling party's supervisory system 48 identifies the call as one for supervision (S400), monitors the call (S402), and determines if the call is answered (S404). As above, in order to determine that a call is not answered, the supervisory system 48 may detect a busy signal, may wait for a predetermined number of rings, or may wait for a predetermined dual tone multifrequency (DTMF) signal, a voice command, or the like from the calling party to indicate an intention to send a message.

If the call is answered, it is then determined if the call has been answered by a call answering or messaging system or by a natural person (S406). Again, as above, the detection of whether or not the call is answered by a call answering or messaging system or a natural human may be achieved automatically by various methods such as those described in U.S. patent application Ser. No. 09/216,971 entitled “Method and System for Estimation of a Source of a Voice Signal” by K. Ramanan or may be indicated by the calling party sending DTMF tones or the like.

If the call is answered by a natural person, the call will proceed in the conventional manner (S408) but the supervisory system 40 will continue to monitor the call to determine if the called party indicates an intention to send a message (S410). For example, the calling party may indicate an intention to send a message due to the call being answered by a different party (for example, a child), because the called party does not have time to talk, or because the calling party or called party determine that a message is more efficient. As above, the indication of an intention to send a message may be a predetermined dual tone DTMF signal, a voice command, or the like. The supervisory system 40 continues monitoring the call until the call ends (S412) at which point the method ends.

If the call is not answered, the call is answered by a call answering or messaging system, or the calling party indicates an intention to send a message, the calling party's supervisory system 48 will determine user information for the called party, including the called party's address information and, if available, information regarding the called party's communication devices' 42 and their capability for sending and receiving various message types (S414).

The determination of the called party's user information can be carried out in a variety of ways. For example, the supervisory system 48 may query its own database 50. Alternatively, the supervisory system 48 may use a similar method to that described above with regard to the first embodiment to query a database 50 of the PSTN and retrieve a voice mail address for the called party. This may then be used to pre-fill the called party's voice mail address in a message compose session at the calling party's supervisory system 48. Further, where the call is detected by the called party's supervisory system 48, this called party's supervisory system 48 may be configured to respond to the calling party via a data path with a message indicating that the called party is unavailable and including the called party's user information as a part of the message. Alternatively, when using Internet Protocol (IP) telephony, the calling party's supervisory system 48 may query an Internet database 50 via a data path to determine the called party's user information. In particular, the called party's user information may include voice mail address, mobile phone address (number), e-mail address, Internet instant messaging address and the like as well as the types of messages that may be received (i.e. available media) at each of the addresses and a respective called party's communication device 42. As another alternative, the supervisory system 48 may use information obtained from a query of one database 50 to query an additional database 50. For example, the supervisory system 48 may use a called party's destination number (DN) to query a local database 50 to obtain the called party's name and then use the called party's name to query an Internet database 50 to retrieve the called party's e-mail address. It will be apparent to one of skill in the art that there are a number of ways to determine a called party's user or address information.

The calling party's supervisory system 48 will then drop the call to the called party while maintaining communication with the calling party (S416). It is noted that the determination of the called party's user and address information may occur through a connection established as a result of the call by the calling party to the called party or this determination may be through an alternate connection. If through an alternate connection, the call to the called party may be dropped prior to making the determination of the address. For example, the supervisory system 48 may drop the call and then use a connection to the Internet 46 to query an Internet database 50 using the called party's telephone number to determine the called party's e-mail address.

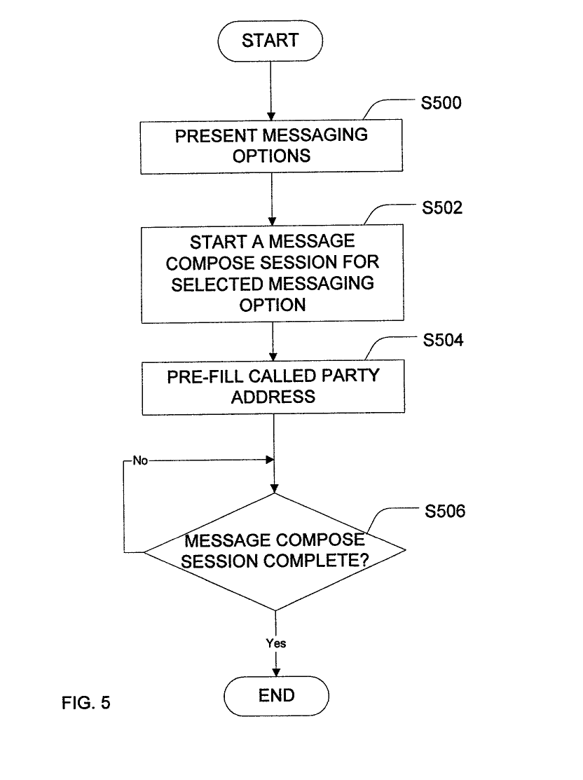

The supervisory system 48 then enters a message compose mode to allow the calling party to compose a message in which the called party's address information will already be entered (S418). In particular, a flowchart for the message compose mode is shown in FIG. 5. Using the available called party addresses that have been determined by one or more queries of one or more databases, the supervisory system 48 presents the available messaging options to allow the calling party to determine the type of message the calling party wishes to compose (S500). The type of messages presented will depend on the address information determined for the called party and in a preferred case will also depend on the capabilities of the communication devices 42 available to the called party and the calling party. For example, if the calling party's communication device 42 is a desktop computer or the like with video capability and the called party has an e-mail address that indicates compatibility with video messaging it may be possible to record and send a video message or e-mail, whereas if the calling party's communication device 42 is a mobile phone and the called party's address information is for a communication device 42 such as a pager, it may be possible to send only a text message or perhaps a voice message.

The calling party then selects a messaging option (i.e. an appropriate message type for an address of the called party to which the calling party would like to send a message) and, based on the calling party's selection, the supervisory system 48 starts a message compose session (S502) and pre-fills the appropriate called party address (S504). The message compose session may be implemented as a part of the supervisory system 48 (as described in this embodiment) or may be implemented separately. For example, the supervisory system 48 could transfer the calling party to a conventional voice messaging system, could issue commands to start an e-mail application at the calling party's communication device 42, or the like. In the case that the calling party would like to send a text message, it may also be preferable that the calling party be able to select from a menu of pre-stored messages.

The supervisory system 48 then waits for the calling party to end the message compose session (S506). The calling party may end the message compose session by, for example, entering DTMF tones, by selecting a “send” button or graphic on a screen of the communication device 42, or as is otherwise known in the art.

Once the calling party completes composing the message the message compose mode ends and, as shown in FIG. 4, the calling party's supervisory system 48 sends the message by an appropriate route (S420) and the communication between the calling party's communication device 42 and the supervisory system 48 ends (S422). As an alternative, it is also possible for the supervisory system 48 to end communication between the calling party's communication device 42 and the supervisory system 48 after the message is composed and prior to sending. As a further alternative, after sending the message, the supervisory system 48 may allow the calling party to access other options or functionality such as retrieving received messages or the like. As a still further alternative, after sending the message, the supervisory system 48 may allow the calling party to return to a conventional call that was put on hold while the message was composed. As yet a still further alternative, the supervisory system 48 may be configured such that the calling party may initiate a message compose mode (such as e-mail) while continuing a conventional call, for example, the calling party may wish to send a drawing by e-mail or the like while continuing the synchronous discussion. In these cases, the called party's address is also determined by the supervisory system 40 and pre-filled in the message.

The invention is intended to enhance messaging from the calling party's point of view. Where a calling party has a supervisory system available or is a subscriber to a supervisory system and cannot have a synchronous call with a called party directly due to a variety of reasons, the call to the called party is terminated, and a message compose session is established for the calling party, with the intended party's address information pre-filled.

Several non-limiting examples are provided to aid in understanding the embodiments of the invention. It will be apparent to one of skill in the art that there are many other possible examples.

In a first example, a calling party subscribes to a supervisory service and in subscribing may give the supervisory service information about their communication devices 42 such as the address (e.g. phone number) and the types of messages that can be sent or received. After subscribing, the calling party may use, for example, a mobile phone to contact a called party at their office telephone number. The supervisory system 48 (for example at the PSTN 14) monitors the call and determines that the call is transferred to a call answering or messaging system. As the call is transferred, the supervisory system 48 may receive/intercept an indication of the destination number (DN) for the called party's call answering or messaging system (which may or may not be different from the first dialed DN). The supervisory system 48 may simultaneously send queries to databases 50 located at the called party's supervisory system 48, at an SCP 18 (as shown in FIG. 1), or on the Internet 46 to determine addresses for the called party. The supervisory system 48 then drops the call leg to the called party but maintains the call leg to the calling party. In a particular case, the supervisory system 48 may have an address for the call answering or messaging system and for e-mail. If the calling party's mobile phone is capable of sending e-mail, the supervisory system 48 presents the calling party with the option of sending a voice message or an e-mail message. For example, the supervisory system 48 may provide a voice prompt indicating that the calling party should press the number one to select a voice message or number two to select an e-mail message. The calling party selects one of the options and the supervisory system 48 then enters the message compose mode to either record the voice message or to record the entry of an e-mail message using the mobile phone keypad. As indicated above, in the case that a mobile phone user selects to send an e-mail, it may be useful for the supervisory system 48 to provide a list of frequently used phrases for faster entry. Once the message is composed, the supervisory system 48 sends the message to the appropriate address.

In a second example, the calling party may be using a telephone connected to a private branch exchange (PBX) to make a call to a called party. The PBX monitors the call to the called party. The calling party determines that the call attempt is unsuccessful and enters a function code or codes on the telephone (by pushing a button or buttons) to indicate to the PBX that the calling party would like to send a message. The PBX transfers the call to a voice mail system (VMS) associated with the PBX and sends the destination number (DN) to the VMS. At this time, the PBX drops the call attempt to the called party. The VMS then searches through available databases for the called party's address information. If the VMS determines a voice mail address, the VMS initiates a message compose session and then sends the completed message to the determined called party voice mail address. In this example, the PBX provides a switching function and the functions of the supervisory system are distributed among the PBX (supervisory function) and the VMS (message compose function).

In the above embodiments, the detection of the called party's user information or address information may also include detection of assistant address information that will allow the calling party the option of attempting a connection with an assistant or directing a message to the assistant rather than to the called party.

As indicated above, it will be understood by one skilled in the art that, depending on the capabilities and functionality of the communication device, a message may be composed in a variety of media, including for example, voice, e-mail, Internet instant messaging, paging, video, fax, and the like. It is also possible that the message may be a conventional letter.

Further, as indicated above, functions of the supervisory system may also be implemented at the communications device or at other parts of the PSTN 14, Internet or other networks and may also be distributed. As a particular example, the functions of the message compose mode could be divided among different parts of the communications system such that one particular type of messaging application may be associated with (situated on/at) the communications device while another messaging application may be associated with (situated on/at) the PSTN 14. Thus, a voice messaging application may be provided on the PSTN 14 while an e-mail messaging application may be provided on the communications device. Similarly, a database for one particular type of information may be associated with (situated on/at) the communications device while a database for another particular type of information may be associated with (situated on/at) the Internet. Thus, the communication device may include a database of contacts that includes e-mail information for the called party while an Internet database may provide alternate address information such as a pager number for the called party.

The embodiments of the invention provide the advantages of reducing or eliminating connect charges for long distance calls, allowing for a variety of types of messages to be composed rather than just a voice message, and allowing a calling party to compose a well thought out message using their own system, having familiar controls, user interface, and personal preferences or the like, and generally giving the calling party the ability to keep a copy of the message sent.

Other modifications will be apparent to those skilled in the art and, therefore, the invention is defined in the claims.

We claim:

1. A method for handling an unsuccessful synchronous call attempt from a calling party to a called party, said method comprising:
monitoring a synchronous call attempt from said calling party to said called party;
determining at least one communication address related to said called party;
dropping said synchronous call attempt to said called party;
allowing said calling party to compose a message; and
sending said message to said determined communication address.

2. The method of claim 1, further comprising determining that said synchronous call attempt to said called party is unsuccessful.

3. The method of claim 2, wherein said determining that said synchronous call attempt to said called party is unsuccessful comprises detecting an indication from the calling party that said synchronous call attempt to said called party is unsuccessful.

4. The method of claim 3, wherein said indication comprises said calling party pressing a predetermined key or keys on a communication device.

5. The method of claim 3, wherein said indication comprises said calling party using a vocal command.

6. The method of claim 1, wherein said dropping occurs prior to said determining said at least one communication address.

7. The method of claim 1, wherein said dropping comprises disconnecting.

8. The method of claim 1, wherein said at least one communication address comprises at least one of a telephone number, pager number, e-mail address, voice messaging address, mobile phone number, and Internet instant messaging address.

9. The method of claim 1, wherein said determining at least one communication address comprises using said called party's telephone number in a query to at least one database for communication addresses for said called party.

10. The method of claim 1, wherein said determining at least one communication address comprises using information about said called party in a query to at least one database to obtain other information about said called party.

11. The method of claim 10, wherein said other information about said called party is used in a query to at least one database to obtain further information about said called party.

12. The method of claim 10, wherein said information about said called party comprises name and communication addresses.

13. The method of claim 1, wherein said allowing said calling party to compose a message comprises:
where said at least one communication address related to the called party comprises a plurality of communication addresses, presenting said calling party with a list of messaging options based on said plurality of communication addresses;
allowing the calling party to select a messaging option for use; and
commencing a message compose session related to said selected messaging option and pre-filling a communication address for said message with a communication address related to said messaging option.

14. The method of claim 13, further comprising determining said called party's communication addresses that are available for use.

15. The method of claim 14, wherein said determining the called party's addresses that are available for use comprises comparing the determined called party's addresses with the message compose capability of a communications device of said calling party.

16. A computer readable medium containing computer executable code which adapts a processor for a communication system to:
monitor a synchronous call attempt from said calling party to said called party;
determine at least one communication address related to said called party;
drop said synchronous call attempt to said called party;
allow said calling party to compose a message; and
send said message to said determined communication address.

17. The computer readable medium of claim 16, further adapting a processor for a communication system to determine that said synchronous call attempt to said called party is unsuccessful.

18. The computer readable medium of claim 17, wherein said determining that said synchronous call attempt to said called party is unsuccessful comprises detecting an indication from the calling party that said synchronous call attempt to said called party is unsuccessful.

19. The computer readable medium of claim 18, wherein said indication comprises said calling party pressing a predetermined key or keys on a communication device.

20. The computer readable medium of claim 18, wherein said indication comprises said calling party using a vocal command.

21. The computer readable medium of claim 16, wherein said at least one communication address comprises at least one of a telephone number, pager number, e-mail address, voice messaging address, mobile phone number, and Internet instant messaging address.

22. The computer readable medium of claim 16, wherein said determining at least one communication address comprises using information about said called party in a query to at least one database to obtain other information about said called party.

23. The computer readable medium of claim 22, wherein said other information about said called party is used in a query to at least one database to obtain further information about said called party.

24. The computer readable medium of claim 16, wherein said allowing said calling party to compose a message comprises:
where said at least one communication address related to the called party comprises a plurality of communication addresses, presenting said calling party with a list of messaging options based on said plurality of communication addresses;
allowing the calling party to select a messaging option for use; and
commencing a message compose session related to said selected messaging option and pre-filling a communication address for said message with a communication address related to said messaging option.

25. The computer readable medium of claim 24, further comprising determining said called party's communication addresses that are available for use.

26. The computer readable medium of claim 25, wherein said determining the called party's addresses that are available for use comprises comparing the determined called party's addresses with the message compose capability of a communications device of said calling party.

27. A method for handling a synchronous call attempt from a calling party to a called party, said method comprising:
monitoring a synchronous call attempt from said calling party to said called party;
detecting an indication from said calling party that said calling party wishes to send a message;
determining at least one communication address related to said called party;
allowing said calling party to compose a message; and
sending said message to said determined communication address.

28. The method of claim 27, wherein said detecting comprises detecting said calling party pressing a predetermined key or keys on a communication device.

29. The method of claim 27, wherein said detecting comprises detecting said calling party using a vocal command.

30. A system for handling an unsuccessful synchronous call attempt from a calling party to a called party, said system comprising:
monitoring means for monitoring a synchronous call attempt from said calling party directed to said called party;
detection means for determining that said synchronous call attempt from said calling party to said called party is unsuccessful;
addressing means for determining at least one address for said called party;
dropping means for dropping said synchronous call attempt to said called party;
message means for allowing said calling party to compose a message for said called party; and
sending means for sending said message to said address determined by said addressing means.

31. The system of claim 30, wherein said addressing means comprises:
at least one database containing said called party's address information;
database query means for querying said database for said called party's address information; and
data communication means for providing said called party's address information to said message means.
